(19) United States
(12) Patent Application Publication
(10) Pub. No.: US 2003/0017770 A1
(43) Pub. Date: Jan. 23, 2003

(54) Protective packing material

(76) Inventor: David A. Bromm, Indianapolis, IN (US)

Correspondence Address: MICHAEL A. SWIFT, ICE MILLER, One American Square, Box 82001, Indianapolis, IN, 46282-0002, US

(21) Appl. No.: 09/909,599

(22) Filed: Jul. 20, 2001

(51) Int. Cl. B32B 5/14; B32B 3/06; B32B 27/12; B32B 27/04; B32B 25/10; B32B 25/02; D03D 15/00; D04B 21/00; B32B 5/26; D03D 19/00; D04B 1/00; D04C 1/00; D04G 1/00; D03D 9/00

(52) U.S. Cl. 442/1; 442/32; 442/49; 428/295.1; 428/297.1; 428/297.4; 428/306.6; 428/308.8; 428/309.9

(57) ABSTRACT

This invention relates to protective packaging materials for use during shipping and/or storage of objects. The packaging material of the present invention, referred to as the protective packing material, comprises a flexible mesh structure and a means for absorbing shock integrated into the flexible mesh structure whereby the invention may be either wrapped around or stuffed in and around one or more objects such that the shock absorbing means absorbs a shock from a blow to the one or more objects thereby protecting the one or more objects from damage and the mesh structure contains the shock absorbing means and prevents the shock absorbing means from scattering.

### BACKGROUND

This invention relates to protective packaging materials for fragile objects. Various types of packaging materials have been, and are being employed for packaging and shipping of perishable or fragile objects. These have included the use of various kinds of packaging material intended to both space and protect objects within an outer box.

For example, a packaging material commonly known as bubble pack or bubble wrap is currently used to provide cushioning for the shipping of fragile objects. However, bubble wrap has inherent disadvantages. Such disadvantages include maintaining the integrity and cushioning ability of the bubble wrap as the air pockets are punctured as a result of coming in contact with the sharp edges of the item being protected or other items being shipped contemporaneously. Moreover, the bubble wrap is not suitable to insure proper spacing between objects and is difficult to force into tight spaces between two objects being shipped in the same container without puncturing. Bubble wrap also acts as an insulator and traps heat and moisture. It does not allow an item to “breath” to release heat and moisture. Trapped moisture could cause damage to an item being shipped.

Another current example of packaging materials is the styrofoam® or other like material formed as “peanuts”. The peanut is essentially extruded and expanded polystyrene or like material that has been manufactured to various sizes and shapes. Such packing materials do a good job of evenly and efficiently filling the spaces surrounding an odd shaped item or items in a box. Furthermore, the peanut has a property of“elastic memory” that allows a crushed or deformed peanut to return to its original shape.

However, the peanut has significant disadvantages. Peanuts are lightweight and as a result tend to scatter everywhere. The peanuts often carry an electrostatic charge that causes them to cling to things, which makes sweeping them up and collecting them difficult. Because they are lightweight, they blow away easily in the wind and are easily scattered into the environment. Once into the environment, the peanuts are a hazard as they can be ingested by animals causing injury or even death.

Thus, what is needed is a new packing material to overcome the deficiencies of current protective packaging approaches as discussed above. Such an invention must be able to provide excellent protective qualities, be reusable, allow flexibility in spacing of multiple items in a container, and comprise a system that will not scatter into the environment after use or between uses.

### SUMMARY

The present invention solves the deficiencies inherent in current packaging materials. The present invention provides excellent protective qualities and is reusable. The present invention also allows flexibility in use in that it can be either used to wrap single and multiple items and/or can be used to space multiple items within a larger container by stuffing the invention between and around multiple items. Further, the present invention, unlike peanuts, will not scatter and is easy to collect and store for future use.

In accordance with the present invention, the protective packing material includes a flexible mesh structure and a means for absorbing shock integrated into the flexible mesh structure. The present invention may be either wrapped around or stuffed in and around one or more objects such that the shock absorbing means absorbs a shock from a blow to the object(s) thereby protecting the object(s) from damage. The mesh structure contains the shock absorbing means and prevents the shock absorbing means from scattering.

These and other advantages and features of the present invention shall hereinafter appear, and for the purposes of illustration, but not limited, exemplary embodiments of the present invention shall hereinafter be described.

### BRIEF DESCRIPTION OF THE DRAWINGS

FIG. 1 is a prospective view of the protective packing material in combination with an object.

FIG. 2 is a prospective view of the protective packing material.

FIG. 3 is a side view of the protective packing material.

FIG. 4 is a perspective view of the present invention utilizing “peanut” shaped shock absorbing nodules.

FIG. 5 is a perspective view of an alternative embodiment of the protective packing material.

### DETAILED DESCRIPTION

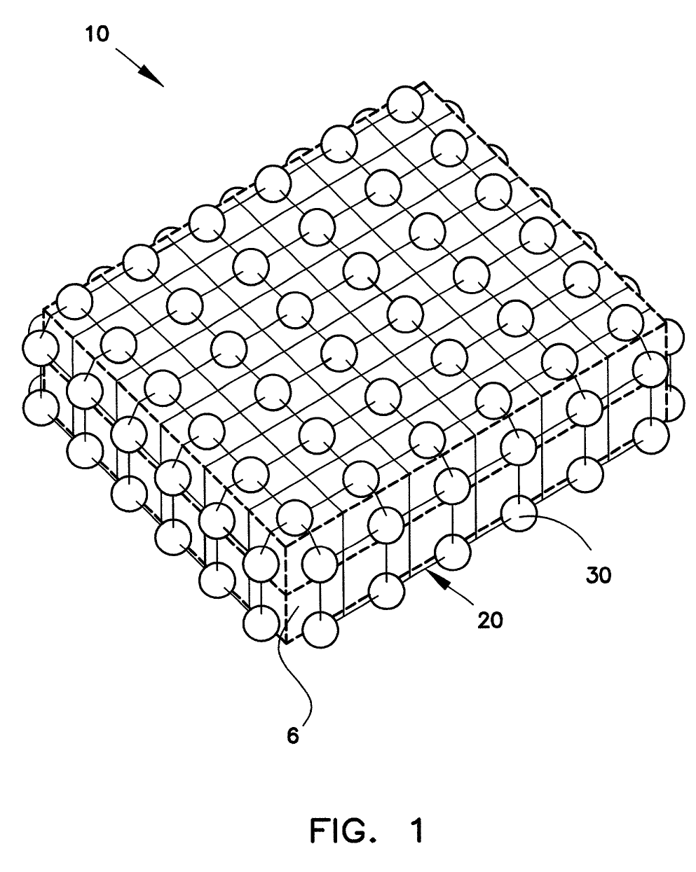

In accordance with the present invention, protective packing material is provided as shown generally in FIGS. 1 through 5 and is indicated by the numeral 10. FIG. 1 shows the invention 10 in combination with an object 6. However, the present invention is not limited in its use to a single object shipped in a single box. The present invention may be used to wrap and protect multiple objects to be shipped or stored in or without an external container. The present invention may also be used to space and protect one or more objects in a container by stuffing it between and around objects. Yet another use of the present invention includes the combination of wrapping objects, placing the wrapped objects in a container, and then using additional packing material of the present invention as a spacer between objects in the container.

In accordance with the present invention, and referring generally to FIGS. 1, 2 and 3, the protective packing material includes a flexible mesh structure 20 that is essentially gridlike or netlike. Specifically referring to FIG. 3, the mesh structure has a top side 22 and a bottom side 24. The mesh structure 20 can be constructed from any suitable material known to one of ordinary skill that is flexible, resilient and strong. Such materials include, but are not limited to, plastics, nylon, rubber, including synthetic rubbers, twine or other stringlike material.

The present invention also includes means for absorbing shock that is integrated into the flexible mesh structure 20, whereby the protective packing material 10 is wrapable around and/or stuffable in and around one or more objections 6. The shock absorbing means are arranged and constructed to protect objects by absorbing the shock from an external force. Further, by integrating the shock absorbing means into the flexible mesh structure 20, the shock absorbing means are easily contained and do not scatter as is the case with packing materials such as styrofoam® “peanuts”.

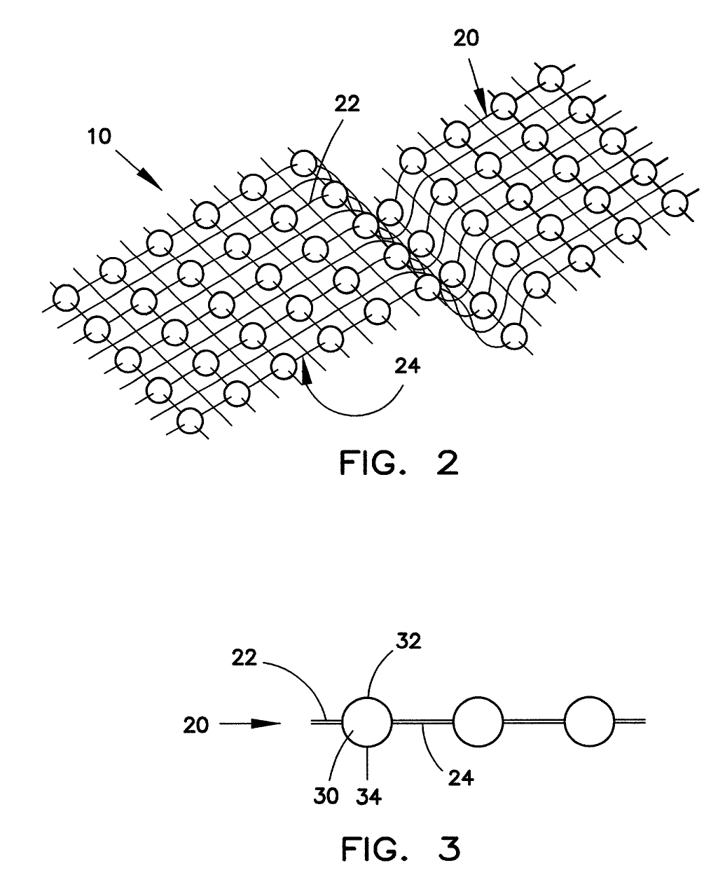

Referring to FIGS. 2 and 3, means for absorbing shock includes multiple nodules 30 having a top portion 32 and a bottom portion 34. The top portion 32 extends outwardly from top side 22 of flexible mesh structure 20. Correspondingly, bottom portion 34 extends outwardly from bottom side 24 of flexible mesh structure 20.

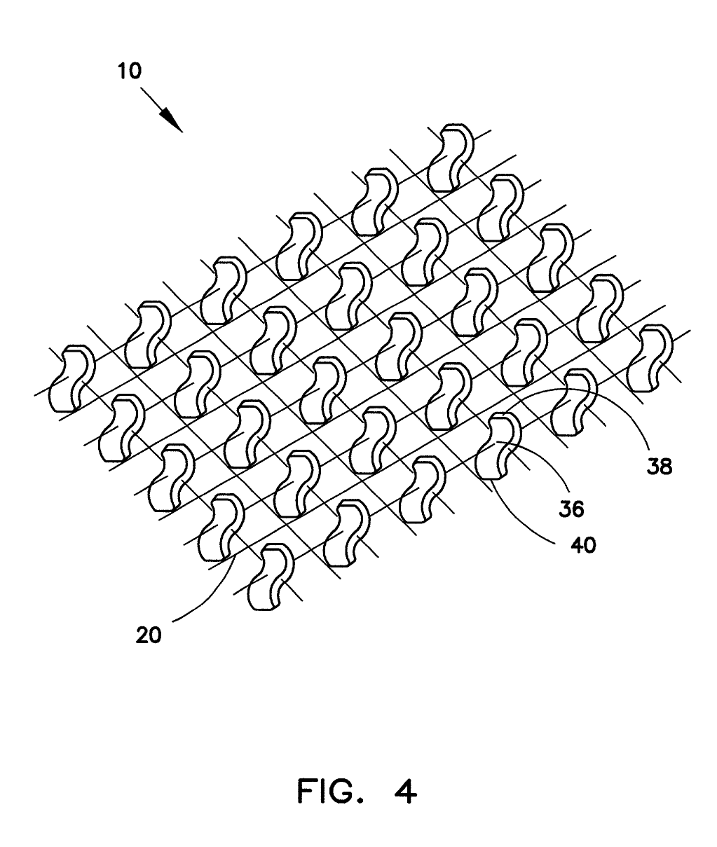

Alternately, and as depicted in FIG. 4, the nodules may be “peanut” shaped 36. Here again the peanut shaped nodules have a top portion 38 extending outwardly from top side 22 and a bottom portion 40 extending outwardly from bottom side 24. However, and not depicted in any figure for obvious reasons, the shock absorbing nodules of any embodiment maybe any suitable and effective geometric shape and size. The size of the shock absorbing nodules is dependent on the choice of one of ordinary skill based upon the anticipated use. For example, large heavy objects may require relatively large nodules to achieve sufficient shock absorbing protection. Alternately, in the case of heavy or large objects, smaller nodules may be used and the requisite protection achieved by wrapping multiple layers of the present invention around the object or objects. Smaller and lighter objects may require smaller nodules to achieve the requisite level of protection.

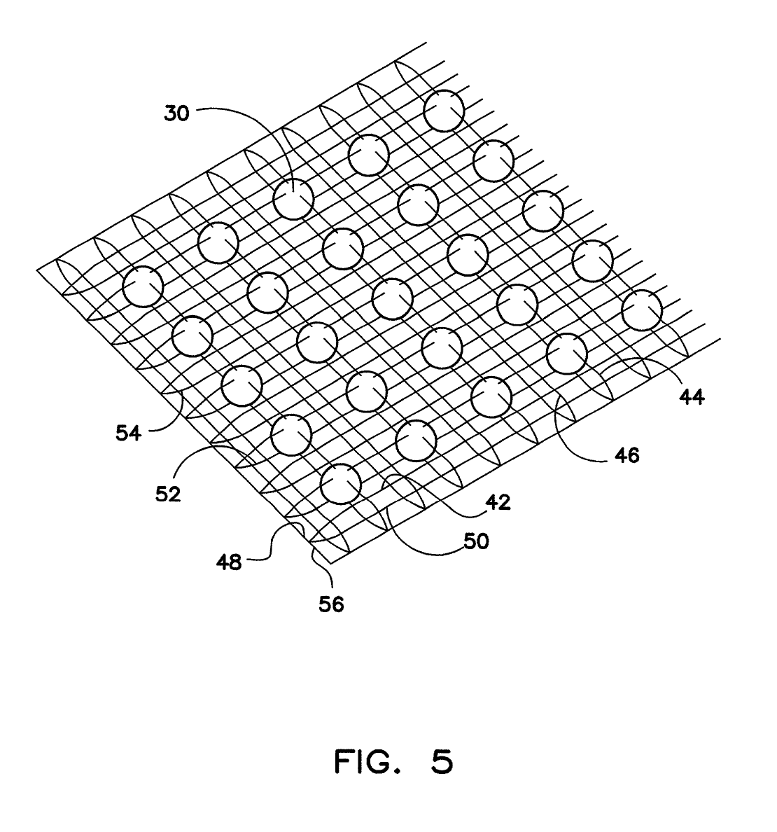

Referring to FIG. 5, another alternate embodiment of the present invention is shown. This alternate embodiment of the invention comprises a first mesh structure 42 having a top side 44, a bottom side 46, and a periphery 48. A second mesh structure 50 is also provided. The second mesh structure 50 has a top side 52, a bottom side 54, and a periphery 56. The periphery 48 of the first mesh structure 42 and the periphery 56 of the second mesh structure 50 are interconnected. Means for absorbing shock are interspersed between the first mesh structure 42 and the second mesh structure 50, such that the shock absorbing means are fixedly retained between the first and second mesh structures. The shock absorbing means again may be nodules of various shapes and sizes depending upon the particular application. FIG. 5, for example, shows spherical shock absorbing nodules 30, however, the shock absorbing nodules may be “peanut” shaped or may be any other suitable and effective geometric shape and/or size.

Any geometric shape suitable for effective shock absorbing or aesthetic considerations is anticipated as within the scope of the present invention. By way of example only, such geometric shapes include but are not limited to spheres, ellipsoids, cylinders, rectangular prisms, cubes, irregular prisms, polyhedrons, and combinations or variations thereof. Choice of shape may be dictated by considerations such as manufacturability, aesthetics, shape and size of objects to be protected, and/or any other relevant consideration of one of ordinary skill in the art.

The shock absorbing nodules 30, 36 may be constructed from any suitable material that provides effective shock absorbing properties, is pliable elastic or rubbery in that such material returns to essentially its original shape after use and/or absorbing a shock, and is integratable into the mesh structure 20. By way of example and without limiting the scope of the present invention, the shock absorbing nodules 30, 36 maybe constructed from styrene polymers, styrene copolymers, natural rubber, synthetic rubber, foam rubber, derivations thereof, and combinations thereof.

As is readily seen, the present invention overcomes the deficiencies associated with current packing materials. Unlike bubble wrap type packing materials that lose their protective qualities once the bubbles are “popped”, crushing the shock absorbing nodules of the present invention will not eliminate its protective qualities. Moreover, depending on the material chosen, the nodules will more or less return to their original shape and functionality once the crushing force is removed. Further, unlike conventional packing materials, use of the present invention allows the protected object to “breath” allowing moisture and/or heat to escape.

The present invention is not only wrapable around one or more objects, but also may be stuffed in and around objects to serve both a protective function and a spacing function. However, unlike the loose “peanut” packing system, the protective packing material allows the shock absorbing nodules to be contained by the mesh structure thereby avoiding the scattering problem of loose “peanut” type packing materials. Scattering is not only eliminated, but the potential for accidental ingestion by animals is greatly reduced.

Other advantages of the present invention include flexibility of use as the protective packing material can be constructed to accommodate any size, weight and shape of object or objects to be protected. This advantage can be achieved by varying the size, shape and material of construction of the shock absorbing nodules and/or the mesh structure. Although other advantages may be found and realized and various modification may be suggested by those skilled in the art, it is understood that the present invention is not to be limited to the details given above, but rather may be modified within the scope of the appended claims.

I claim:

1. A packing material for use in protecting at least one object comprising:
(a) a flexible mesh structure having a top side and a bottom side; and
(b) means for absorbing shock integrated into the flexible mesh structure at intervals along the length and width of the mesh structure whereby the packing material may be either wrapable around or stuffed in and around one or more objects such that the shock absorbing means absorbs a shock from a blow to the one or more objects thereby protecting the one or more objects from damage and whereby the mesh structure retains the shock absorbing means and prevents the shock absorbing means from scattering.

2. The packing material of claim 1 wherein the flexible mesh structure and the means for absorbing shock are a unitary single molded piece.

3. The packing material of claim 1, whereby the flexible mesh structure is constructed from at least one material chosen from plastic, nylon, rubber, synthetic rubber, fabric, natural fibers, synthetic fibers and twine.

4. The packing material of claim 1, whereby the shock absorbing means consists of more than one shock absorbing nodule, the shock absorbing nodules having a top portion and a bottom portion, the shock absorbing nodules integrate into the mesh structure such that the top portion extends outwardly from the top side and the bottom portion extends outwardly from the bottom side of the mesh structure.

5. The packing material of claim 4, whereby each of the nodules are evenly spaced throughout the mesh structure.

6. The packing material of claim 5, wherein the nodules are formed into an effective three dimensional geometric shape.

7. The packing material of claim 6, wherein the nodules are made of a material chosen from styrene polymers, styrene copolymers, natural rubber, synthetic rubber, foam rubber, derivations thereof, and combinations thereof.

8. An apparatus, comprising:
a. a flexible mesh structure; and
b. shock absorbing nodules integrated into the flexible mesh structure at intervals along the length and width of said mesh structure, whereby the packing material maybe either wrapable around or stuffed in and around one or more objects such that the shock absorbing means absorbs a shock from a blow to the one or more objects thereby protecting the one or more objects from damage and whereby the mesh structure contains the shock absorbing means and prevents the shock absorbing means from scattering.

9. The apparatus of claim 8 wherein the flexible mesh structure and shock absorbing nodules are a unitary single molding.

10. The apparatus of claim 8, whereby the flexible mesh structure is constructed from at least one material chosen from plastic, nylon, rubber, synthetic rubber, fabric, natural fibers, synthetic fibers and twine.

11. The apparatus of claim 8 whereby the shock absorbing nodules have a top portion and a bottom portion, the shock absorbing nodules integrate into and space throughout the mesh structure such that the top portion extends outwardly from the top side and the bottom portion extends outwardly from the bottom side.

12. The apparatus of claim 11, whereby each of the nodules are evenly spaced throughout the mesh structure.

13. The apparatus of claim 12, wherein the nodules are formed into an effective three dimensional geometrical shape.

14. The apparatus of claim 13, wherein the nodules are made of a material chosen from styrene polymers, styrene copolymers, natural rubber, synthetic rubber, foam rubber, derivations thereof, and combinations thereof.

15. A packing material comprising:
a. a first mesh structure having a top side, a bottom side, and a periphery;
b. a second mesh structure having a top side, a bottom side, and a periphery, the periphery of the second mesh structure and the periphery of the first mesh structure being interconnected; and
c. means for absorbing shock interspersed between the first mesh structure and the second mesh structure, such that the shock absorbing means are fixedly retained between the first and second mesh structures.

16. The packing material of claim 15, whereby the first mesh structure and the second mesh structure are constructed from at least one material chosen from plastic, nylon, rubber, synthetic rubber, fabric, natural fibers, synthetic fibers and twine.

17. The packing material of claim 15, whereby the shock absorbing means consists of more than one shock absorbing nodule.

18. The packing material of claim 17, wherein the shock absorbing nodules are formed into an effective three dimensional geometric shape.

19. The packing material of claim 18, wherein the shock absorbing nodules are made of a material chosen from styrene polymers, styrene co-polymers, natural rubber, synthetic rubber, foam rubber, and derivations thereof, and combinations thereof.
